(19) United States
(12) Patent Application Publication
(10) Pub. No.: US 2009/0001330 A1
(43) Pub. Date: Jan. 1, 2009

(54) Electrical Insulating Oil Compositions and Preparation Thereof

(75) Inventors: Jan L. Arickx, Deinze (BE); Johan R. Luycx, Geraardsbergen (BE)

Correspondence Address: CHEVRON CORPORATION, P.O. BOX 6006, SAN RAMON, CA, 94583-0806, US

(73) Assignee: Chevron U.S.A. Inc., San Ramon, CA (US)

(21) Appl. No.: 11/769,910

(22) Filed: Jun. 28, 2007

(51) Int. Cl. H01B 3/22; C09K 5/00; H01B 3/20

(52) U.S. Cl. 252/574; 252/570; 252/575; 252/578; 252/73

(57) ABSTRACT

An electrical insulating oil composition is prepared from an isomerized base oil. The electrical insulating oil composition in one embodiment exhibits excellent sulphur corrosion protection property with a sulphur level of <5 ppm; excellent gassing tendency of <30 μL per minute as measured according to ASTM D-2300-1976, and a rotary pressure vessel oxidation stability (RPVOT) value of at least 400 minutes as measured according to ASTM D 2272-02.

### TECHNICAL FIELD

The invention relates generally to electrical insulating oil compositions, and more specifically to electrical insulating oil compositions made from isomerized base oils.

### BACKGROUND

Electrical insulating oils (or sometimes called “electrical oils” or “transformer oils”) are essential in the transmission of electrical power. They are manufactured to provide extremely low electrical conductivity, meaning with high resistance to passing an electric current. Also because transferring electricity generates a great deal of heat, electrical insulating oils are required for their cooling capability. Due to the high performance requirements, specifications were developed to ensure that fluids from different manufacturers are interchangeable, including the American Society for Testing and Materials (ASTM), the International Electrotechnical Commission (IEC), the British Standard (BS) and the German specifications DIN 57370/VDE 0370.

Electrical insulating oil compositions in the prior art typically employ a Group I, II, III, V (napthenic oil), a synthetic PAO (for poly α-olefin) or mixtures thereof as a base oil stock. The groups are broad categories of base stocks developed by the American Petroleum Institute (API) for the purpose of creating guidelines for base oils. The petroleum-based oils function satisfactorily, but they are not readily biodegradable.

Recent reforming processes have formed a new class of oil, e.g., Fischer Tropsch base oil (FTBO), wherein the oil, fraction, or feed originates from or is produced at some stage by a Fischer-Tropsch process. The feedstock for a Fischer-Tropsch process may come from a wide variety of hydrocarbonaceous resources, including biomass, natural gas, coal, shale oil, petroleum, municipal waste, derivatives of these, and combinations thereof. Crude product prepared from the Fischer-Tropsch process comprises a mixture of various solid, liquid, and gaseous hydrocarbons, which can be refined into products such as diesel oil, naphtha, wax, and other liquid petroleum or specialty products.

In a number of patent publications and applications, i.e., US 2006/0289337, US2006/0201851, US2006/0016721, US2006/0016724, US2006/0076267, US2006/020185, US2006/013210, US2005/0241990, US2005/0077208, US2005/0139513, US2005/0139514, US2005/0133409, US2005/0133407, US2005/0261147, US2005/0261146, US2005/0261145, US2004/0159582, U.S. Pat. No. 7,018,525, U.S. Pat. No. 7,083,713, U.S. application Ser. Nos. 11/400,570, 11/535,165 and 11/613,936, which are incorporated herein by reference, a Fischer Tropsch base oil is produced from a process in which the feed is a waxy feed recovered from a Fischer-Tropsch synthesis. The process comprises a complete or partial hydroisomerization dewaxing step, using a dual-functional catalyst or a catalyst that can isomerize paraffins selectively. Hydroisomerization dewaxing is achieved by contacting the waxy feed with a hydroisomerization catalyst in an isomerization zone under hydroisomerizing conditions.

U.S. Patent Publication Nos. 2006/0113216 and 2006/0113512 disclose dielectric fluids comprising Fischer Tropsch base oils. WO2006136591 discloses a high oxidation resistant oil products for use as for a transformer oil or a switch gear oil, the composition comprises one or more base oils selected from mineral-derived naphthenic base oils, mineral-derived paraffic base oils, or Fischer-Tropsch derived base oils, wherein the base oil is subjected to a clay treatment to remove polar compounds from the oil formulation.

There is a still need for an electrical insulating oil having reduced gassing tendency, improved corrosion protection, and excellent biodegradability.

### SUMMARY OF THE INVENTION

In one embodiment, there is provided an electrical insulating oil composition in compliance with at least one of ASTM D 3487-2000 and IEC 60296-2003 and a biodegradability of at least 30% as measured according to OECD 301D, the composition comprising (a) a lubricating base oil having consecutive numbers of carbon atoms and has less than 10 wt % naphthenic carbon by n-d-M; (b) 0.001 to 10 wt % at least an additive selected from an additive package, an oxidation inhibitor, anti-gassing agent, pour point depressant, metal deactivator, metal passivator, anti-foaming agent, and mixtures thereof.

In another embodiment, the electrical insulating oil composition comprises between 0.001 to 1 wt. % triazole derivative as the metal deactivator and between 0.001 to 1 wt. % of at least an aromatic amine as the antioxidant.

In another aspect, an electrical insulating oil composition having excellent sulphur corrosion protection, a biodegradability of at least 30% as measured according to OECD 301D, and meeting IEC 60296 requirements is provided. The composition comprises: (a) a lubricating base oil having consecutive numbers of carbon atoms and has less than 10 wt % naphthenic carbon by n-d-M; (b) 0.001 to 1 wt % of at least a triazole derivative as a metal deactivator; and (c) 0.001 to 1 wt. % of at least an aromatic amine as an antioxidant.

### DETAILED DESCRIPTION

The following terms will be used throughout the specification and will have the following meanings unless otherwise indicated.

As used herein, the terms “electrical insulating oil,” “transformer oil,” “dielectric fluid,” “transformer fluid” may be used interchangeably, referring to a composition that can be used for insulating/cooling power and distribution electrical equipment, and meeting electrical insulating oil specifications and testing protocol defined by the American Society for Testing and Materials (ASTM D-3487) and the European specifications 60296 as defined by the International Electrical Commission (IEC).

“Fischer-Tropsch derived” means that the product, fraction, or feed originates from or is produced at some stage by a Fischer-Tropsch process. As used herein, “Fischer-Tropsch base oil” may be used interchangeably with “FT base oil,” “FTBO,” “GTL base oil” (GTL: gas-to-liquid), or “Fischer-Tropsch derived base oil.”

As used herein, “isomerized base oil” refers to a base oil made by isomerization of a waxy feed.

As used herein, a “waxy feed” comprises at least 40 wt % n-paraffins. In one embodiment, the waxy feed comprises greater than 50 wt % n-paraffins. In another embodiment, greater than 75 wt % n-paraffins. In one embodiment, the waxy feed also has very low levels of nitrogen and sulphur, e.g., less than 25 ppm total combined nitrogen and sulfur, or in other embodiments less than 20 ppm. Examples of waxy feeds include slack waxes, deoiled slack waxes, refined foots oils, waxy lubricant raffinates, n-paraffin waxes, NAO waxes, waxes produced in chemical plant processes, deoiled petroleum derived waxes, microcrystalline waxes, Fischer-Tropsch waxes, and mixtures thereof. In one embodiment, the waxy feeds have a pour point of greater than 50° C. In another embodiment, greater than 60° C.

As used herein, “pour point reducing blend component” refers to an isomerized waxy product with relatively high molecular weights and a specified degree of alkyl branching in the molecule, such that it reduces the pour point of lubricating base oil blends containing it. Examples of a pour point reducing blend component are disclosed in U.S. Pat. Nos. 6,150,577 and 7,053,254, and Patent Publication No. US 2005-0247600 A1. A pour point reducing blend component can be: 1) an isomerized Fischer-Tropsch derived bottoms product; 2) a bottoms product prepared from an isomerized highly waxy mineral oil, or 3) an isomerized oil having a kinematic viscosity at 100° C. of at least about 8 mm²/s made from polyethylene plastic.

As used herein, the “10 percent point” of the boiling range of a pour point reducing blend component refers to the temperature at which 10 weight percent of the hydrocarbons present within that cut will vaporize at atmospheric pressure. Similarly, the 90 percent point of the respective boiling ranges refers to the temperature at which 90 weight percent of the hydrocarbons present within that cut will vaporize at atmospheric pressure. For samples having a boiling range above 1000° F. (538° C.), the boiling range can be measured using the standard analytical method D-6352-04 or its equivalent. For samples having a boiling range below 1000° F. (538° C.), the boiling range distributions in this disclosure can be measured using the standard analytical method D-2887-06 or its equivalent. It will be noted that only the 10 percent point of the respective boiling range is used when referring to the pour point reducing blend component that is a vacuum distillation bottoms product, since it is derived from a bottoms fraction which makes the 90 percent point or upper boiling limit irrelevant.

“Kinematic viscosity” is a measurement in mm²/s of the resistance to flow of a fluid under gravity, determined by ASTM D445-06.

“Viscosity index” (VI) is an empirical, unit-less number indicating the effect of temperature change on the kinematic viscosity of the oil. The higher the VI of an oil, the lower its tendency to change viscosity with temperature. Viscosity index is measured according to ASTM D 2270-04.

Cold-cranking simulator apparent viscosity (CCS VIS) is a measurement in millipascal seconds, mPa.s to measure the viscometric properties of lubricating base oils under low temperature and high shear. CCS VIS is determined by ASTM D 5293-04.

The boiling range distribution of base oil, by wt %, is determined by simulated distillation (SIMDIS) according to ASTM D 6352-04, “Boiling Range Distribution of Petroleum Distillates in Boiling Range from 174 to 700° C. by Gas Chromatography.”

“Noack volatility” is defined as the mass of oil, expressed in weight %, which is lost when the oil is heated at 250° C. with a constant flow of air drawn through it for 60 min., measured according to ASTM D5800-05, Procedure B.

Brookfield viscosity is used to determine the internal fluid-friction of a lubricant during cold temperature operation, which can be measured by ASTM D 2983-04.

“Pour point” is a measurement of the temperature at which a sample of base oil will begin to flow under certain carefully controlled conditions, which can be determined as described in ASTM D 5950-02.

“Auto ignition temperature” is the temperature at which a fluid will ignite spontaneously in contact with air, which can be determined according to ASTM 659-78.

“Ln” refers to natural logarithm with base “e.”

“Traction coefficient” is an indicator of intrinsic lubricant properties, expressed as the dimensionless ratio of the friction force F and the normal force N, where friction is the mechanical force which resists movement or hinders movement between sliding or rolling surfaces. Traction coefficient can be measured with an MTM Traction Measurement System from PCS Instruments, Ltd., configured with a polished 19 mm diameter ball (SAE AISI 52100 steel) angled at 220 to a flat 46 mm diameter polished disk (SAE AISI 52100 steel). The steel ball and disk are independently measured at an average rolling speed of 3 meters per second, a slide to roll ratio of 40 percent, and a load of 20 Newtons. The roll ratio is defined as the difference in sliding speed between the ball and disk divided by the mean speed of the ball and disk, i.e. roll ratio=(Speed1−Speed2)/((Speed1+Speed2)−/2).

As used herein, “consecutive numbers of carbon atoms” means that the base oil has a distribution of hydrocarbon molecules over a range of carbon numbers, with every number of carbon numbers in-between. For example, the base oil may have hydrocarbon molecules ranging from C22 to C36 or from C30 to C60 with every carbon number in-between. The hydrocarbon molecules of the base oil differ from each other by consecutive numbers of carbon atoms, as a consequence of the waxy feed also having consecutive numbers of carbon atoms. For example, in the Fischer-Tropsch hydrocarbon synthesis reaction, the source of carbon atoms is CO and the hydrocarbon molecules are built up one carbon atom at a time. Petroleum-derived waxy feeds have consecutive numbers of carbon atoms. In contrast to an oil based on poly-alpha-olefin (“PAO”), the molecules of an isomerized base oil have a more linear structure, comprising a relatively long backbone with short branches. The classic textbook description of a PAO is a star-shaped molecule, and in particular tridecane, which is illustrated as three decane molecules attached at a central point. While a star-shaped molecules is theoretical, nevertheless PAO molecules have fewer and longer branches that the hydrocarbon molecules that make up the isomerized base oil disclosed herein.

“Molecules with cycloparaffinic functionality” mean any molecule that is, or contains as one or more substituents, a monocyclic or a fused multicyclic saturated hydrocarbon group.

“Molecules with monocycloparaffinic functionality” mean any molecule that is a monocyclic saturated hydrocarbon group of three to seven ring carbons or any molecule that is substituted with a single monocyclic saturated hydrocarbon group of three to seven ring carbons.

“Molecules with multicycloparaffinic functionality” mean any molecule that is a fused multicyclic saturated hydrocarbon ring group of two or more fused rings, any molecule that is substituted with one or more fused multicyclic saturated hydrocarbon ring groups of two or more fused rings, or any molecule that is substituted with more than one monocyclic saturated hydrocarbon group of three to seven ring carbons.

Molecules with cycloparaffinic functionality, molecules with monocycloparaffinic functionality, and molecules with multicycloparaffinic functionality are reported as weight percent and are determined by a combination of Field Ionization Mass Spectroscopy (FIMS), HPLC-UV for aromatics, and Proton NMR for olefins, further fully described herein.

Oxidator BN measures the response of a lubricating oil in a simulated application. High values, or long times to adsorb one liter of oxygen, indicate good stability. Oxidator BN can be measured via a Dornte-type oxygen absorption apparatus (R. W. Dornte “Oxidation of White Oils,” Industrial and Engineering Chemistry, Vol. 28, page 26, 1936), under 1 atmosphere of pure oxygen at 340° F., time to absorb 1000 ml of O₂ by 100 g. of oil is reported. In the Oxidator BN test, 0.8 ml of catalyst is used per 100 grams of oil. The catalyst is a mixture of soluble metal-naphthenates simulating the average metal analysis of used crankcase oil. The additive package is 80 millimoles of zinc bispolypropylenephenyldithiophosphate per 100 grams of oil.

Molecular characterizations can be performed by methods known in the art, including Field Ionization Mass Spectroscopy (FIMS) and n-d-M analysis (ASTM D 3238-95 (Re-approved 2005)). In FIMS, the base oil is characterized as alkanes and molecules with different numbers of unsaturations. The molecules with different numbers of unsaturations may be comprised of cycloparaffins, olefins, and aromatics. If aromatics are present in significant amount, they would be identified as 4-unsaturations. When olefins are present in significant amounts, they would be identified as 1-unsaturations. The total of the 1-unsaturations, 2-unsaturations, 3-unsaturations, 4-unsaturations, 5-unsaturations, and 6-unsaturations from the FIMS analysis, minus the wt % olefins by proton NMR, and minus the wt % aromatics by HPLC-UV is the total weight percent of molecules with cycloparaffinic functionality. If the aromatics content was not measured, it was assumed to be less than 0.1 wt % and not included in the calculation for total weight percent of molecules with cycloparaffinic functionality. The total weight percent of molecules with cycloparaffinic functionality is the sum of the weight percent of molecules with monocyclopraffinic functionality and the weight percent of molecules with multicycloparaffinic functionality.

Molecular weights are determined by ASTM D2503-92 (Reapproved 2002). The method uses thermoelectric measurement of vapour pressure (VPO). In circumstances where there is insufficient sample volume, an alternative method of ASTM D2502-94 may be used; and where this has been used it is indicated.

Density is determined by ASTM D4052-96 (Reapproved 2002). The sample is introduced into an oscillating sample tube and the change in oscillating frequency caused by the change in the mass of the tube is used in conjunction with calibration data to determine the density of the sample.

Weight percent olefins can be determined by proton-NMR according to the steps specified herein. In most tests, the olefins are conventional olefins, i.e. a distributed mixture of those olefin types having hydrogens attached to the double bond carbons such as: alpha, vinylidene, cis, trans, and trisubstituted, with a detectable allylic to olefin integral ratio between 1 and 2.5. When this ratio exceeds 3, it indicates a higher percentage of tri or tetra substituted olefins being present, thus other assumptions known in the analytical art can be made to calculate the number of double bonds in the sample. The steps are as follows: A) Prepare a solution of 5-10% of the test hydrocarbon in deuterochloroform. B) Acquire a normal proton spectrum of at least 12 ppm spectral width and accurately reference the chemical shift (ppm) axis, with the instrument having sufficient gain range to acquire a signal without overloading the receiver/ADC, e.g., when a 30 degree pulse is applied, the instrument having a minimum signal digitization dynamic range of 65,000. In one embodiment, the instrument has a dynamic range of at least 260,000. C) Measure the integral intensities between: 6.0-4.5 ppm (olefin); 2.2-1.9 ppm (allylic); and 1.9-0.5 ppm (saturate). D) Using the molecular weight of the test substance determined by ASTM D 2503-92 (Reapproved 2002), calculate: 1. The average molecular formula of the saturated hydrocarbons; 2. The average molecular formula of the olefins; 3. The total integral intensity (=sum of all integral intensities); 4. The integral intensity per sample hydrogen (=total integral/number of hydrogens in formula); 5. The number of olefin hydrogens (=Olefin integral/integral per hydrogen); 6. The number of double bonds (=Olefin hydrogen times hydrogens in olefin formula/2); and 7. The wt % olefins by proton NMR=100 times the number of double bonds times the number of hydrogens in a typical olefin molecule divided by the number of hydrogens in a typical test substance molecule. In this test, the wt % olefins by proton NMR calculation procedure, D, works particularly well when the percent olefins result is low, less than 15 wt %.

Weight percent aromatics in one embodiment can be measured by HPLC-UV. In one embodiment, the test is conducted using a Hewlett Packard 1050 Series Quaternary Gradient High Performance Liquid Chromatography (HPLC) system, coupled with a HP 1050 Diode-Array UV-V is detector interfaced to an HP Chem-station. Identification of the individual aromatic classes in the highly saturated base oil can be made on the basis of the UV spectral pattern and the elution time. The amino column used for this analysis differentiates aromatic molecules largely on the basis of their ring-number (or double-bond number). Thus, the single ring aromatic containing molecules elute first, followed by the polycyclic aromatics in order of increasing double bond number per molecule. For aromatics with similar double bond character, those with only alkyl substitution on the ring elute sooner than those with naphthenic substitution. Unequivocal identification of the various base oil aromatic hydrocarbons from their UV absorbance spectra can be accomplished recognizing that their peak electronic transitions are all red-shifted relative to the pure model compound analogs to a degree dependent on the amount of alkyl and naphthenic substitution on the ring system. Quantification of the eluting aromatic compounds can be made by integrating chromatograms made from wavelengths optimized for each general class of compounds over the appropriate retention time window for that aromatic. Retention time window limits for each aromatic class can be determined by manually evaluating the individual absorbance spectra of eluting compounds at different times and assigning them to the appropriate aromatic class based on their qualitative similarity to model compound absorption spectra.

HPLC-UV Calibration. In one embodiment, HPLC-UV can be used for identifying classes of aromatic compounds even at very low levels, e.g., multi-ring aromatics typically absorb 10 to 200 times more strongly than single-ring aromatics. Alkyl-substitution affects absorption by 20%. Integration limits for the co-eluting 1-ring and 2-ring aromatics at 272 nm can be made by the perpendicular drop method. Wavelength dependent response factors for each general aromatic class can be first determined by constructing Beer's Law plots from pure model compound mixtures based on the nearest spectral peak absorbances to the substituted aromatic analogs. Weight percent concentrations of aromatics can be calculated by assuming that the average molecular weight for each aromatic class was approximately equal to the average molecular weight for the whole base oil sample.

NMR analysis. In one embodiment, the weight percent of all molecules with at least one aromatic function in the purified mono-aromatic standard can be confirmed via long-duration carbon 13 NMR analysis. The NMR results can be translated from % aromatic carbon to % aromatic molecules (to be consistent with HPLC-UV and D 2007) knowing that 95-99% of the aromatics in highly saturated base oils are single-ring aromatics. In another test to accurately measure low levels of all molecules with at least one aromatic function by NMR, the standard D 5292-99 (Reapproved 2004) method can be modified to give a minimum carbon sensitivity of 500:1 (by ASTM standard practice E 386) with a 15-hour duration run on a 400-500 MHz NMR with a 10-12 mm Nalorac probe. Acorn PC integration software can be used to define the shape of the baseline and consistently integrate.

Extent of branching refers to the number of alkyl branches in hydrocarbons. Branching and branching position can be determined using carbon-13 (¹³C) NMR according to the following nine-step process: 1) Identify the CH branch centers and the CH₃ branch termination points using the DEPT Pulse sequence (Doddrell, D. T.; D. T. Pegg; M. R. Bendall, Journal of Magnetic Resonance 1982, 48, 323ff.). 2) Verify the absence of carbons initiating multiple branches (quaternary carbons) using the APT pulse sequence (Patt, S. L.; J. N. Shoolery, Journal of Magnetic Resonance 1982, 46, 535ff.). 3) Assign the various branch carbon resonances to specific branch positions and lengths using tabulated and calculated values known in the art (Lindeman, L. P., Journal of Qualitative Analytical Chemistry 43, 1971 1245ff; Netzel, D. A., et. al., Fuel, 60, 1981, 307ff). 4) Estimate relative branching density at different carbon positions by comparing the integrated intensity of the specific carbon of the methyl/alkyl group to the intensity of a single carbon (which is equal to total integral/number of carbons per molecule in the mixture). For the 2-methyl branch, where both the terminal and the branch methyl occur at the same resonance position, the intensity is divided by two before estimating the branching density. If the 4-methyl branch fraction is calculated and tabulated, its contribution to the 4+methyls is subtracted to avoid double counting. 5) Calculate the average carbon number. The average carbon number is determined by dividing the molecular weight of the sample by 14 (the formula weight of CH₂). 6) The number of branches per molecule is the sum of the branches found in step 4. 7) The number of alkyl branches per 100 carbon atoms is calculated from the number of branches per molecule (step 6) times 100/average carbon number. 8) Estimate Branching Index (BI) by ¹H NMR Analysis, which is presented as percentage of methyl hydrogen (chemical shift range 0.6-1.05 ppm) among total hydrogen as estimated by NMR in the liquid hydrocarbon composition. 9) Estimate Branching proximity (BP) by ¹³C NMR, which is presented as percentage of recurring methylene carbons—which are four or more carbons away from the end group or a branch (represented by a NMR signal at 29.9 ppm) among total carbons as estimated by NMR in the liquid hydrocarbon composition. The measurements can be performed using any Fourier Transform NMR spectrometer, e.g., one having a magnet of 7.0 T or greater. After verification by Mass Spectrometry, UV or an NMR survey that aromatic carbons are absent, the spectral width for the ¹³C NMR studies can be limited to the saturated carbon region, 0-80 ppm vs. TMS (tetramethylsilane). Solutions of 25-50 wt. % in chloroform-d1 are excited by 30 degrees pulses followed by a 1.3 seconds (sec.) acquisition time. In order to minimize non-uniform intensity data, the broadband proton inverse-gated decoupling is used during a 6 sec. delay prior to the excitation pulse and on during acquisition. Samples are doped with 0.03 to 0.05 M Cr (acac)₃(tris(acetylacetonato)-chromium (III)) as a relaxation agent to ensure full intensities are observed. The DEPT and APT sequences can be carried out according to literature descriptions with minor deviations described in the Varian or Bruker operating manuals. DEPT is Distortionless Enhancement by Polarization Transfer. The DEPT 45 sequence gives a signal all carbons bonded to protons. DEPT 90 shows CH carbons only. DEPT 135 shows CH and CH₃ up and CH₂ 180 degrees out of phase (down). APT is attached proton test, known in the art. It allows all carbons to be seen, but if CH and CH₃ are up, then quaternaries and CH₂ are down. The branching properties of the sample can be determined by ¹³C NMR using the assumption in the calculations that the entire sample was iso-paraffinic. The unsaturates content may be measured using Field Ionization Mass Spectroscopy (FIMS).

In one embodiment, the electrical insulating composition comprises a number of components, including additives, in a matrix of base oil.

Base Oil Matrix Component: In one embodiment, the base oil or blends thereof comprises at least an isomerized base oil which the product itself, its fraction, or feed originates from or is produced at some stage by isomerization of a waxy feed from a Fischer-Tropsch process (“Fischer-Tropsch derived base oils”). In another embodiment, the base oil comprises at least an isomerized base oil made from a substantially paraffinic wax feed (“waxy feed”).

Fischer-Tropsch derived base oils are disclosed in a number of patent publications, including for example U.S. Pat. Nos. 6,080,301, 6,090,989, and 6165949, and US Patent Publication No. US2004/0079678A1, US20050133409, US20060289337. Fischer-Tropsch process is a catalyzed chemical reaction in which carbon monoxide and hydrogen are converted into liquid hydrocarbons of various forms including a light reaction product and a waxy reaction product, with both being substantially paraffinic.

In one embodiment the isomerized base oil has consecutive numbers of carbon atoms and has less than 10 wt % naphthenic carbon by n-d-M. In yet another embodiment the isomerized base oil made from a waxy feed has a kinematic viscosity at 100° C. between 1.5 and 3.5 mm²/s.

In one embodiment, the isomerized base oil is made by a process in which the hydroisomerization dewaxing is performed at conditions sufficient for the base oil to have: a) a weight percent of all molecules with at least one aromatic functionality less than 0.30; b) a weight percent of all molecules with at least one cycloparaffinic functionality greater than 10; c) a ratio of weight percent molecules with monocycloparaffinic functionality to weight percent molecules with multicycloparaffinic functionality greater than 20 and d) a viscosity index greater than 28×Ln(Kinematic viscosity at 100° C.)+80.

In another embodiment, the isomerized base oil is made from a process in which the highly paraffinic wax is hydroisomerized using a shape selective intermediate pore size molecular sieve comprising a noble metal hydrogenation component, and under conditions of 600-750° F. (315-399° C.) In the process, the conditions for hydroisomerization are controlled such that the conversion of the compounds boiling above 700° F. (371° C.) in the wax feed to compounds boiling below 700° F. (371° C.) is maintained between 10 wt % and 50 wt %. A resulting isomerized base oil has a kinematic viscosity of between 1.0 and 3.5 mm²/s at 100° C. and a Noack volatility of less than 50 weight %. The base oil comprises greater than 3 weight % molecules with cycloparaffinic functionality and less than 0.30 weight percent aromatics.

In one embodiment the isomerized base oil has a Noack volatility less than an amount calculated by the following equation: 1000×(Kinematic Viscosity at 100° C.)^{-2.7}. In another embodiment, the isomerized base oil has a Noack volatility less than an amount calculated by the following equation: 900×(Kinematic Vicosity at 100° C.)^{-2.8}. In a third embodiment, the isomerized base oil has a Kinematic Vicosity at 100° C. of >1.808 mm²/s and a Noack volatility less than an amount calculated by the following equation: 1.286+20(Kinematic Viscosity at 100° C.)^{-1.5}+551.8 Ln(Kinematic Vicosity at 100° C.). In a fourth embodiment, the isomerized base oil has a kinematic viscosity at 100° C. of less than 4.0 mm²/s, and a wt % Noack volatility between 0 and 100. In a fifth embodiment, the isomerized base oil has a kinematic viscosity between 1.5 and 4.0 mm²/s and a Noack volatility less than the Noack volatility calculated by the following equation: 160−40(Kinematic Viscosity at 100° C.).

In one embodiment, the isomerized base oil has a kinematic viscosity at 100° C. in the range of 2.4 and 3.8 mm²/s and a Noack volatility less than an amount defined by the equation: 900×(Kinematic Viscosity at 100° C.)^{-2.8}−15). For kinematic viscosities in the range of 2.4 and 3.8 mm²/s, the equation: 900×(Kinematic Viscosity at 100° C.)^{-2.8}−15) provides a lower Noack volatility than the equation: 160−40(Kinematic Viscosity at 100° C.)

In one embodiment, the isomerized base oil is made from a process in which the highly paraffinic wax is hydroisomerized under conditions for the base oil to have a kinematic viscosity at 100° C. of 3.6 to 4.2 mm²/s, a viscosity index of greater than 130, a wt % Noack volatility less than 12, a pour point of less than −9° C.

In one embodiment, the isomerized base oil has an auto-ignition temperature (AIT) greater than the AIT defined by the equation: AIT in ° C.=1.6×(Kinematic Viscosity at 40° C., in mm2/s)+300. In a second embodiment, the base oil as an AIT of greater than 329° C. and a viscosity index greater than 28×Ln(Kinematic Viscosity at 100° C., in mm²/s)+100.

In one embodiment, the isomerized base oil has a relatively low traction coefficient, specifically, its traction coefficient is less than an amount calculated by the equation: traction coefficient=0.009×Ln(kinematic viscosity in mm²/s)−0.001, wherein the kinematic viscosity in the equation is the kinematic viscosity during the traction coefficient measurement and is between 2 and 50 mm²/s. In one embodiment, the isomerized base oil has a traction coefficient of less than 0.023 (or less than 0.021) when measured at a kinematic viscosity of 15 mm²/s and at a slide to roll ratio of 40%. In another embodiment the isomerized base oil has a traction coefficient of less than 0.017 when measured at a kinematic viscosity of 15 mm²/s and at a slide to roll ratio of 40%. In another embodiment the isomerized base oil has a viscosity index greater than 150 and a traction coefficient less than 0.015 when measured at a kinematic viscosity of 15 mm²/s and at a slide to roll ratio of 40 percent.

In some embodiments, the isomerized base oil having low traction coefficients also displays a higher kinematic viscosity and higher boiling points. In one embodiment, the base oil has a traction coefficient less than 0.015, and a 50 wt % boiling point greater than 565° C. (1050° F.). In another embodiment, the base oil has a traction coefficient less than 0.011 and a 50 wt % boiling point by ASTM D 6352-04 greater than 582° C. (1080° F.).

In some embodiments, the isomerized base oil having low traction coefficients also displays unique branching properties by NMR, including a branching index less than or equal to 23.4, a branching proximity greater than or equal to 22.0, and a Free Carbon Index between 9 and 30. In one embodiment, the base oil has at least 4 wt % naphthenic carbon, in another embodiment, at least 5 wt % naphthenic carbon by n-d-M analysis by ASTM D 3238-95 (Reapproved 2005).

In one embodiment, the isomerized base oil is produced in a process wherein the intermediate oil isomerate comprises paraffinic hydrocarbon components, and in which the extent of branching is less than 7 alkyl branches per 100 carbons, and wherein the base oil comprises paraffinic hydrocarbon components in which the extent of branching is less than 8 alkyl branches per 100 carbons and less than 20 wt % of the alkyl branches are at the 2 position. In one embodiment, the FT base oil has a pour point of less than −8° C.; a kinematic viscosity at 100° C. of at least 3.2 mm²/s; and a viscosity index greater than a viscosity index calculated by the equation of =22×Ln(kinematic viscosity at 100° C.)+132.

In one embodiment, the base oil comprises greater than 10 wt. % and less than 70 wt. % total molecules with cycloparaffinic functionality, and a ratio of weight percent molecules with monocycloparaffinic functionality to weight percent molecules with multicycloparaffinic functionality greater than 15.

In one embodiment, the isomerized base oil has an average molecular weight between 600 and 1100, and an average degree of branching in the molecules between 6.5 and 10 alkyl branches per 100 carbon atoms. In another embodiment, the isomerized base oil has a kinematic viscosity between about 8 and about 25 mm²/s and an average degree of branching in the molecules between 6.5 and 10 alkyl branches per 100 carbon atoms.

In one embodiment, the isomerized base oil is obtained from a process in which the highly paraffinic wax is hydroisomerized at a hydrogen to feed ratio from 712.4 to 3562 liter H₂/liter oil, for the base oil to have a total weight percent of molecules with cycloparaffinic functionality of greater than 10, and a ratio of weight percent molecules with monocycloparaffinic functionality to weight percent molecules with multicycloparaffinic functionality of greater than 15. In another embodiment, the base oil has a viscosity index greater than an amount defined by the equation: 28×Ln(Kinematic viscosity at 100° C.)+95. In a third embodiment, the base oil comprises a weight percent aromatics less than 0.30; a weight percent of molecules with cycloparaffinic functionality greater than 10; a ratio of weight percent of molecules with monocycloparaffinic functionality to weight percent of molecules with multicycloparaffinic functionality greater than 20; and a viscosity index greater than 28×Ln(Kinematic Viscosity at 100° C.)+110. In a fourth embodiment, the base oil further has a kinematic viscosity at 100° C. greater than 6 mm²/s. In a fifth embodiment, the base oil has a weight percent aromatics less than 0.05 and a viscosity index greater than 28×Ln(Kinematic Viscosity at 100° C.)+95. In a sixth embodiment, the base oil has a weight percent aromatics less than 0.30, a weight percent molecules with cycloparaffinic functionality greater than the kinematic viscosity at 100° C., in mm²/s, multiplied by three, and a ratio of molecules with monocycloparaffinic functionality to molecules with multicycloparaffinic functionality greater than 15.

In one embodiment, the isomerized base oil contains between 2 and 10% naphthenic carbon as measured by n-d-M. In one embodiment, the base oil has a kinematic viscosity of 1.5-3.0 mm²/s at 100° C. and 2-3% naphthenic carbon. In another embodiment, a kinematic viscosity of 1.8-3.5 mm²/s at 100° C. and 2.5-4% naphthenic carbon. In a third embodiment, a kinematic viscosity of 3-6 mm²/s at 100° C. and 2.7-5% naphthenic carbon. In a fourth embodiment, a kinematic viscosity of 10-30 mm²/s at 100° C. and greater than 5.2% naphthenic carbon.

In one embodiment, the isomerized base oil has an average molecular weight greater than 475; a viscosity index greater than 140, and a weight percent olefins less than 10. The base oil improves the air release and low foaming characteristics of the mixture when incorporated into the electrical insulating oil composition.

In one embodiment, the isomerized base oil is a white oil as disclosed in U.S. Pat. No. 7,214,307 and US Patent Publication US20060016724. In one embodiment, the isomerized white base oil has a kinematic viscosity at 100° C. between about 1.5-36 mm²/s; a viscosity index greater than an amount calculated by the equation: Viscosity Index=28×Ln(the Kinematic Viscosity at 100° C.)+105, less than 18 wt. % molecules with cycloparaffinic functionality, a pour point less than 0° C., and a Saybolt color of +20 or greater. In another embodiment, the isomerized base oil is a white oil having a kinematic viscosity at 100° C. between about 1.5 cSt and 36 mm²/s, a viscosity index greater than an amount calculated by the equation: Viscosity Index=28×Ln(the Kinematic Viscosity at 100° C.)+95, between 5 and less than 18 weight percent molecules with cycloparaffinic functionality, less than 1.2 weight percent molecules with multicycloparaffinic functionality, a pour point less than 0° C. and a Saybolt color of +20 or greater.

In one embodiment, the isomerized base oil has a kinematic viscosity at 100° C. between 2-7 mm²/s; a kinematic viscosity at 40° C. between 6-20 mm²/s; a viscosity index between 115 and 150; pour point in the range of −20 and −60° C.; molecular weight of 350-550; density in the range of 0.795 to 0.825; paraffinic carbon in the range of 93-97%; naphthenic carbon in the range of 3-7%; oxidator BN of 35 to 60 hours; bromine index of 18 to 28; and TGA Noack in wt. % of 10 to 80 as measured by ASTM D5800-05 Procedure B.

In one embodiment, the electrical insulating composition employs a base oil that consists of at least one of the isomerized base oils described above. In another embodiment, the composition consists essentially of at least a Fischer-Tropsch base oil. As used herein, the expression “consisting essentially of” permits the inclusion of components that do not materially affect the basic and novel characteristics of the composition under consideration. In yet another embodiment, the composition employs at least a Fischer-Tropsch base oil and optionally 5 to 50 wt. % of at least another type of oil, e.g., conventionally used mineral oils, synthetic hydrocarbon oils or synthetic ester oils, or mixtures thereof depending on the application. Mineral lubricating oil base stocks can be any conventionally refined base stocks derived from paraffinic, naphthenic and mixed base crudes. Other synthetic oils that can be used include synthetic hydrocarbons such as polyalphaolefins; alkyl benzenes, e.g., alkylate bottoms from the alkylation of benzene with tetrapropylene, or the copolymers of ethylene and propylene; silicone oils, e.g., ethyl phenyl polysiloxanes, methyl polysiloxanes, etc. Other suitable synthetic oils include the polyphenyl ethers, e.g., those having from 3 to 7 ether linkages and 4 to 8 phenyl groups. Other suitable synthetic oils include polyisobutenes, and alkylated aromatics such as alkylated naphthalenes.

Additional Components:

In one embodiment, the electrical insulating composition further contains at least an additive such as anti-gassing agents, pour point depressants, metal deactivators, anti-foaming agents, anti-oxidants (oxidation inhibitors), additives for corrosive sulphur and static electrification (metal passivators), dyes, markers, biocides, antistatic additives, and other additives known in the art, in a sufficient amount to provide the desired effects. In one embodiment, this sufficient amount is 0.001 to 10 wt. %. In another embodiment, in an amount of 0.005 to 6 wt. %.

In one embodiment, the electrical insulating oil comprises an additive package containing at least one of the above additive materials, specifically designed for improved pour point, improved cooling properties, improved oxidation stability, and improved dielectric stability.

In one embodiment for improved gas absorption properties, the electrical oil insulating composition further comprises anti-gassing agents to reduce the gassing tendency to +30 μL/min. or less, in another embodiment to 15 μL/min. or less, in a third embodiment to 5 μL/min. or less, according to ASTM Test Method D2300. In one embodiment, the amount is less than 2 wt. %. Low gassing performance is important because, if hydrogen is evolved due to electrical stress, a liquid having low gassing tendency tends to absorb the evolved hydrogen and thereby reduce the chances of an explosion.

In one embodiment, the composition comprises at least a polyarylalkane compound as an anti-gassing compound. Examples include compositions commercially available from Elf Atochem S.A. for use in dielectric fluid compositions. In yet another embodiment, the anti-gassing agent(s) are anti-gassing aromatic(s) other than phenolic compounds either comprising one or more labile hydrogen atom or comprising diaryls, which may or may not comprise one or more labile hydrogen atoms. Examples of suitable anti-gassing agents include, but are not necessarily limited to diaryls and agents having from 9 to 11 carbon atoms selected from the group of alkyl-substituted aromatic compounds, alkyl substituted, partially saturated aromatic compounds, and combinations thereof. In another embodiment, the composition comprises an anti-gassing agent selected from the group consisting of alkyl substituted or unsubstituted biphenyl and alkyl substituted or unsubstituted diaryl alkanes.

In yet another embodiment, the anti-gassing compound is a hydrogen-donating additive, i.e., molecules that incorporate within them labile hydrogen atoms. Such hydrogen donors include alkyl substituted or unsubstituted, partially saturated poling aromatics (e.g. polyaromatics with some degree of saturation), alkylated one ring aromatics (e.g. alkylated benzenes), or alkylated polyring aromatics. In other examples, the anti-gassing additive may be any compound or mixture of compounds, which is a hydrogen donor other than an unsubstituted aromatic compound, e.g., a bicyclic, partially saturated, aromatic compound, or an alkylated benzene compound. Examples of such bicyclic, partially saturated compounds include di- and tetra-hydronaphthalene compounds, alkylated hydronaphthalene compounds such as an alkylated tetrahydronaphthalene. In one embodiment, the anti-gassing compound is a hydrogen donor selected from dihydrophenanthrene, phenyl ortho xylyl ethane, alkylated benzenes, Dowtherm RPT™ (tetrahydro-5-(1-phenylethyl)-naphthalene), acenapthene, tetrahydronaphthalene, alkylated tetrahydronaphthalenes, and tetrahydroquinoline.

In one embodiment, the electrical insulating oil composition further comprises from 0.10 to 5.0 wt. % of a pour point depressant capable of lowering the pour point to below the lowest temperature expected for the climate in which the electrical insulating oil is to be used. This would normally be a temperature of −30° C. to −40° C. In one embodiment, the pour point depressant is an alkylated polystyrene. Other illustrative pour point depressants include esters of maleic anhydride-styrene copolymers, polymethacrylates, polyacrylates, polyacrylamides, condensation products of haloparaffin waxes and aromatic compounds, vinyl carboxylate polymers, and terpolymers of dialkylfumarates, vinyl esters of fatty acids, ethylene-vinyl acetate copolymers, alkyl phenol formaldehyde condensation resins, alkyl vinyl ethers, olefin copolymers, fumeric acid esters, polymethacrylate chemicals such as Acryloid™ 155C made by RohMax, and mixtures thereof.

In another embodiment, the pour point depressant is a pour point reducing blend component. In one embodiment, the pour point reducing blend component is an isomerized Fischer-Tropsch derived vacuum distillation bottoms product, which is a high boiling syncrude fraction which has been isomerized under controlled conditions to give a specified degree of alkyl branching in the molecule. Syncrude prepared from the Fischer-Tropsch process comprises a mixture of various solid, liquid, and gaseous hydrocarbons. When the Fischer-Tropsch waxes are converted into Fischer-Tropsch base oils by various processes, such as by hydroprocessing and distillation, the base oils produced fall into different narrow-cut viscosity ranges. The bottoms that remains after recovering the lubricating base oil cuts from the vacuum column is generally unsuitable for use as a lubricating base oil itself and is usually recycled to a hydrocracking unit for conversion to lower molecular weight products.

In one embodiment, the pour point reducing blend component is an isomerized Fischer-Tropsch derived vacuum distillation bottoms product having an average molecular weight between 600 and 1100 and an average degree of branching in the molecules between 6.5 and 10 alkyl branches per 100 carbon atoms. Generally, the higher molecular weight hydrocarbons are more effective as pour point reducing blend components than the lower molecular weight hydrocarbons. In one embodiment, a higher cut point in a vacuum distillation unit which results in a higher boiling bottoms material is used to prepare the pour point reducing blend component. The higher cut point also has the advantage of resulting in a higher yield of the distillate base oil fractions. In one embodiment, the pour point reducing blend component is an isomerized Fischer-Tropsch derived vacuum distillation bottoms product having a pour point that is at least 3° C. higher than the pour point of the distillate base oil it is blended with.

In one embodiment, the 10 percent point of the boiling range of the pour point reducing blend component that is a vacuum distillation bottoms product is between about 850° F.-1050° F. (454-565° C.). In another embodiment, the pour point reducing blend component is derived from either Fischer-Tropsch or petroleum products, having a boiling range above 950° F. (510° C.), and contains at least 50 percent by weight of paraffins. In yet another embodiment the pour point reducing blend component has a boiling range above 1050° F. (565° C.)

In another embodiment, the pour point reducing blend component is an isomerized petroleum derived base oil containing material having a boiling range above about 1050° F. In one embodiment, the isomerized bottoms material is solvent dewaxed prior to being used as a pour point reducing blend component. The waxy product further separated during solvent dewaxing from the pour point reducing blend component were found to display excellent improved pour point depressing properties compared to the oily product recovered after the solvent dewaxing.

In one embodiment, the pour point reducing blend component has an average degree of branching in the molecules within the range of from 6.5 to 10 alkyl branches per 100 carbon atoms. In another embodiment, the Pour point reducing blend component has an average molecular weight between 600-1100. In a third embodiment, between 700-1000. In one embodiment, the pour point reducing blend component has a kinematic viscosity at 100° C. of 8-30 mm²/s, with the 10% point of the boiling range of the bottoms falling between about 850-1050° F. In yet another embodiment, the pour point reducing blend component has a kinematic viscosity at 100° C. of 15-20 mm²/s and a pour point of −8 to −12° C.

In another embodiment, the pour point reducing blend component is an isomerized oil having a kinematic viscosity at 100° C. of at least about 8 mm²/s made from polyethylene plastic. In one embodiment the pour point reducing blend component is made from waste plastic. In another embodiment the pour point reducing blend component is made from a process comprising: pyrolysis of polyethylene plastic, separating out a heavy fraction, hydrotreating the heavy fraction, catalytic isomerizing the hydrotreated heavy fraction, and collecting the pour point reducing blend component having a kinematic viscosity at 100° C. of at least about 8 mm²/s. In one embodiment, the pour point reducing blend component derived from polyethylene plastic has a boiling range above 1050° F. (565° C.), or even a boiling range above 1200° F. (649° C.).

In one embodiment, the additive comprises (a) methylenebis(di-n-butyldithiocarbamate); and (b) a diphenylamine derivative of tolutriazole or benzotriazole, in a ratio of (a) to (b) of 4:1 to about 50:1. Since metal, specifically copper, is always present in the electrical environment, metal deactivators can be added to the composition in an amount from 0.10 to less than 1.5%. Examples include benzotriazole derivatives to reduce the catalytic activity of copper in electrical apparatus. In some embodiments, the deactivator is a benzotriazole derivative, e.g., a triazole derivative, N,N-bis(2-Ethylhexyl)-1H-1,2,4-triazole-1 methanamine such as IRGAMET™ 30 from Ciba Geigy.

In one embodiment, the electrical oil insulating composition further comprises 0.01 wt. % to 3.0 wt. % of at least an antioxidant (oxidation inhibitor) to improve oxidation stability of the dielectric liquid, thereby minimizing the development of oil sludge and acidity during storage, processing, and service. Minimizing oxidation minimizes electrical conduction and metal corrosion, maximizes system life, maximizes electrical breakdown strength, and ensures satisfactory heat transfer. Examples of antioxidants include but are not limited to hindered phenols, cinnamate type phenolic esters, and alkylated diphenylamines. In one embodiment, the antioxidants are selected from the group consisting of 2,6-ditertiary-butyl para-cresol, 2,6-ditertiary butylphenol, and combinations thereof. An example is a combination of 2,6-ditertiary-butyl para-cresol and 2,6-ditertiary butylphenol. Other examples include but are not limited to, phenol type (phenolic) oxidation inhibitors, e.g., 2,6-di-tert-butyl-4-ethylphenol, 4′-methylene-bis(2,6-di-tert-butylphenol), 4,4′-bis(2,6-di-tert-butylphenol), 4,4′-bis(2-methyl-6-tert-butylphenol), 2,2′-methylene-bis(4-methyl-6-tert-butylphenol), 4,4′-butylidene-bis(3-methyl-6-tert-butylphenol), 4,4′-isopropylidene-bis(2,6-di-tert-butylphenol), 2,2′-methylene-bis(4-methyl-6-nonylphenol), 2,2′-isobutylidene-bis(4,6-dimethylphenol), 2,6-di-tert-butyl-4-methylphenol, 2,2′-5-methylene-bis(4-methyl-6-cyclohexylphenol), 2,4-dimethyl-6-tert-butyl-phenol, 2,6-di-tert-1-dimethylamino-p-cresol, 2,6-di-tert-4-(N,N′-dimethylaminomethylphenol), 4,4′-thiobis(2-methyl-6-tert-butylphenol), 2,2′-thiobis(4-methyl-6-tert-butylphenol), bis(3-methyl-4-hydroxy-5-tert-10-butylbenzyl)-sulfide, alkylated diphenylamine, bis(3,5-di-tert-butyl-4-hydroxybenzyl), phenyl-alpha-naphthylamine, and alkylated-alpha-naphthylamine. Other types of oxidation inhibitors include metal dithiocarbamate (e.g., zinc dithiocarbamate), and 15-methylenebis(dibutyldithiocarbamate).

One example of an oxidation inhibitor is Additin™ RC 9308 manufactured by Rhein Chemie Rheinau GmbH, Germany, containing ca. 1.5 wt-% of C12-C14-t-alkylamines (CAS number 68955-53-3), ca. 4 wt-% of tolyltriazol (CAS number 29385-43-1), and ca. 3.4 wt-% tributyl phosphate (CAS number 126-73-8). This substance contains, besides the antioxidant, also a corrosion inhibitor. Other applicable additives are RC 7110 (2,6-Di-tert.butyl-4-methylphenol) and RC 6301 by the same manufacturer, or mixtures including RC 7110+RC 9308 and RC 7110+RC 6301.

In one embodiment, the electrical insulating oil composition comprises from 0.001 to 1 wt. % of a triazole derivative metal deactivator and 0.05 to 1 wt. % of a phenolic anti-oxidant. In a second embodiment, the composition comprises from 0.003 to 0.8 wt. % of a copper deactivator and to 0.10 to 0.50 wt. % of a solid phenolic anti-oxidant.

In one embodiment the electrical insulating oil composition comprises (i) from 0.05 to 3.0 wt. % of at least one hindered phenol antioxidant, and (ii) from 0.01 to 1.5 wt. % of a metal deactivator. Examples of hindered phenolic antioxidants include 2,6 di-tert-butylphenol, 2,6 di-tert-butylparacresol and mixtures thereof. In one embodiment, the metal deactivator is a tolyltriazole metal deactivator such as 1,2,3 tolyltriazole. Examples include a reaction product of a tolyltriazole and an alkylated diphenyl amine.

Method for Making:

Additives used in formulating the electrical insulating oil composition can be blended into the base oil matrix individually or in various sub-combinations. In one embodiment, all of the components are blended concurrently using an additive concentrate (i.e., additives plus a diluent, such as a hydrocarbon solvent). The use of an additive concentrate takes advantage of the mutual compatibility afforded by the combination of ingredients when in the form of an additive concentrate.

In another embodiment, the electrical insulating oil composition is prepared by mixing the base oil matrix with the separate additives or additive package(s) at an appropriate temperature, such as approximately 60° C., until homogeneous. Nitrogen blankets are used during manufacturing to keep water levels in the composition below the specified limits.

Properties:

The electrical insulating composition meets relevant specifications for physical, electrical, and chemical properties for electrical oils provided by ASTM D 3487-2000 as well as IEC 60296-2003.

In one embodiment, the composition displays excellent oxidation resistance and low gassing tendency with a gassing tendency of <30 μL per minute as measured according to ASTM D-2300-1976 and a rotary pressure vessel oxidation stability (RPVOT) value of at least 400 minutes as measured according to ASTM D 2272-02. In one embodiment, the composition has a gassing tendency of <20 μL per minute. In another embodiment, the composition has an RPVOT of at least 500 minutes.

In one embodiment, the electrical insulating oil composition shows OECD 301D levels ranging from inherently biodegradable of >30% to readily biodegradable of >90%. In one embodiment, the electrical insulating oil composition has a kinematic viscosity at 40° C. of <100 mm²/s (H) and an OECD 301D biodegrability of about 30%. In a second embodiment, the composition has a kinematic viscosity at 40° C. of <40 mm²/s (M) and an OECD 301D biodegrability of about 40%. In a third embodiment, the composition has a kinematic viscosity at 40° C. of <8 mm²/s (L) and an OECD 301D biodegrability of >=40%. In a fourth embodiment, the composition has a kinematic viscosity at 40° C. of <11 mm²/s (XL) and an OECD 301D biodegradability of about 80%. In a fifth embodiment, the composition has a kinematic viscosity at 40° C. of <6 mm²/s (XL) and an OECD 301D biodegradability of >93%.

In one embodiment, the composition displays excellent sulphur corrosion property, with a sulphur content of less than 10 ppm. In a second embodiment, the composition has a sulphur content of <5 ppm. In a third embodiment, less than 1 ppm.

In one embodiment when subjected to the acid sludge test (ASTM D2440), the composition produces a % sludge by mass at 72 hours of 0.15 or less and a 72 hour “total acid number” or “TAN” of 0.5 or less (mg of KOH/g).

In one embodiment, the electrical insulating oil composition meets all ASTM physical property requirements for electrical oils include, but are not necessarily limited to: a color of about 0.5 or less, as measured using Test Method D1500; a flash point of 145° C. or greater, as measured using Test Method D92; an interfacial tension of 40 dynes/cm or more at 25° C. as measured using Test Method D971; a pour point of less than −40° C., as measured using Test Method D92; a relative density of 0.91 or less, according to Test Method D 1298; a visual examination of clear and bright, according to Test Method D1524; and, a viscosity of less than 76 mm²/s at 0° C., less than 12.0 mm²/s at 40° C., and 3.0 mm²/s or less at 100° C., as measured by Test Method D445.

In one embodiment, the electrical insulating oil composition also meets the electrical property requirements for electrical oils, including but not necessarily limited to the ASTM requirements of: a dielectric breakdown voltage of 30 kV or more at 60 Hz by disc electrodes, according to Test Method D877; a dielectric breakdown voltage of 20 kV or more at 60 Hz and a 1.02 mm (0.040-inch) gap using new oil by D1816; a dielectric breakdown voltage impulse of 145 kV or more at 25° C. using a needle-to-sphere grounded 25.4 mm (1-inch) gap, according to Test Method D3300, and, a power factor at 60 Hz of 0.05% or less at 25° C. and of 0.30% or less at 100° C. using Test Method D924.

In one embodiment, the electrical insulating oil composition also meets the chemical property requirements for electrical oils, including but not necessarily limited to the ASTM requirements of: an oxidation inhibitor content of 0.08 wt. % or less, and for Type II oils of 0.3 wt. % or less, as measured using Test Method D2668, or, where the oxidation inhibitor is 2,6-ditertiary butyl cresol, as measured using Test Method D 1473; a low content of elemental sulfur and thermally unstable sulfur-bearing compounds to prevent corrosion of certain metals such as copper and silver in contact with the dielectric liquid, according to Test Method D1274; 35 ppm or less water according to Test Method D1533; a neutralization number of 0.03 mg KOH/g or less, using Test Method D974; and, a non-detectible polychlorinated biphenyl (PCB) content, or a content of less than 1 ppm, as measured using Test Method D4059.

Applications:

In one embodiment, the electrical insulating oil is used to insulate, cool, and lubricate high voltage electrical equipment such as power and distribution transformers, circuit breakers (switches), capacitors (condensers), and insulating cables. In another embodiment, the composition is used in cable applications, regulators, and rectifiers within electrical power systems. In a third embodiment, the oil is used in medical equipment (X-Ray, MRI), and in industrial and academic R&D applications (sonar, etc.). Moving parts include a transmission, a hydrostatic transmission, a gear box, a drive, a hydraulic system, etc.

The following Examples are given as non-limitative illustration of aspects of the present invention.

### EXAMPLES

Unless specified otherwise, the compositions are prepared by mixing the components in the amounts indicated in the Examples. The components used in the Examples are listed below.

FT base oils are available from Chevron Corporation of San Ramon, Calif.

IRGAMET™ 30 is N,N-bis(2-Ethylhexyl)-1H-1,2,4-triazole-1 methanamine from Ciba Geigy.

Additin™ RC 7110 is a phenolic antioxidant 2,6-di-terbutyl-p-cresol 2,6-di-terbutyl-p-cresol from Rhein Chemie Rheinau GmbH.

DPPC is 2,6-di-tert-butyl-p-cresol, antioxidant commercially available from a number of sources.

Synesstic™ 5 is an alkylated apthalene from ExxonMobil.

### Example 1

An electrical insulating formulation containing 99.835 wt. % FTBO XXL (WOW9841), 0.005 wt. % IRGAMET™ 30 and 0.16 wt. % Additin™ RC 7110 was subject to testing against IEC 60296 (2003). The results in Table 1 showed that the formulation is in full compliance, with a total sulphur level of less than 0.001% for excellent corrosion protection properties (not a requirement in IEC 60296).

TABLE 1

| | | Requirement for | Requirement for | Test |
|---|---|---|---|---|
| Test Property | Test method | Transformer oil | Switchgear oil | results |
| FUNCTION | | | | |
| Viscosity 40° C., mm²/s | ISO 3104 | <=12 | <=3.5 | 7.95 |
| Viscosity −30° C., mm²/s | ISO 3104 | <=1800 | — | 209 |
| Viscosity −40° C., mm²/s | ISO 3104 | — | <=400 | 747 |
| Pour point ° C. | ISO 3016 | >−40 | >−60 | −42 |
| Water content, mg/kg | IEC 60814 | <=30 bulk | <=30 bulk | 12 |
| | | <=40 drum | <=40 drum | |
| Break-down voltage kv/2.5 mm | IEC 610156 | >30 | >30 | 72 |
| | | >70 - treated | >70 - treated | |
| DDF/90° C. | IEC 60247 | <=50 * 10⁻⁴ | <=50 * 10⁻⁴ | 22 * 10⁻⁴ |
| STABILITY | | | | |
| Appearance | IEC 60296 | Clear | Clear | Clear |
| Acidity mg KOH/g | ISO 6616 | <=0.01 | <=0.01 | <0.01 |
| Interfacial tension mN/m | ISO 6295 | >40 | >40 | 41 |
| Total sulphur, % | IP 373 | Not specified | Not specified | 0.001 |
| Corrosive sulphur | DIN 51353 | non-corrosive | non-corrosive | non-corrosive |
| Antioxidant additive | IEC 60666 | 0.08-0.40% | 0.08-0.40% | 0.20% |
| | | inhibited oil | inhibited oil | |
| 2-furfural content, mg/kg | IEC 61198 | <=0.1 | <=0.1 | <=0.1 |
| PERFORMANCE | | | | |
| Oxidation stability | IEC 61125C | | | |
| Total acidity, mg KOH/g | | <=1.2 | <=1.2 | 0.09 |
| Sludge % | | <=0.8 | <=0.8 | 0.01 |
| DFF/90° C. | | <=5000 * 10⁻⁴ | <=5000 * 10⁻⁴ | 70 * 10⁻⁴ |
| Gassing tendency @50 HZ | IEC 60628A | Not specified | Not specified | 37.9 |
| after 120 min. | | | | |
| HEALTH SAFETY | | | | |
| Flash point ° C. | ISO 2719 | >135 | >100 | 170 |
| Density/20° C., kg/l | ISO 3675 | <=0.895 | <=0.895 | 0.800 |
| PCA, % | IP 346 | <=3 | <=3 | <0.5 |
| PCB | IEC 61619 | Not detected | Not detected | Not detected |

### Example 2

An electrical insulating formulation containing 99.835 wt. % FTBO XL (WOW9843), 0.005 wt. % IRGAMET™ 30 and 0.16 wt. % Additin™ RC 7110 was subject to testing against IEC 60296 (2003). The results showed that the formulation is in full compliance, with a total sulphur level of less than 1 ppm for excellent corrosion protection properties (not a requirement in IEC 60296).

TABLE 2

| | | Required for | |
|---|---|---|---|
| Test Property | Test method | Transformer oil | Test results |
| Physical characteristics | | | |
| Appearance | IEC 60296 | Clear | Clear |
| Color | ISO 2049 | — | 0.5 |
| Density at 20° C. | ISO 3675 | <=0.895 | 0.803 |
| Flash point ° C. (closed cup Pensky Martens) | ISO 2719 | >135 | 198 |
| Pour point ° C. | ISO 3016 | >−40 | −42 |
| Viscosity 40° C., mm²/s | ISO 3104 | <=12 | 9.3 |
| Viscosity 20° C., mm²/s | ISO 3104 | — | 18.3 |
| CCS Viscosity −15° C., mm²/s | ISO 3104 | — | 102.4 |
| CCS Viscosity −30° C., mm²/s | ISO 3104 | <=1800 | 354.1 |
| Interfacial tension mN/m | ISO 6295 | >40 | 50.4 |
| Chemical characteristics | | | |
| Acidity mg KOH/g | ISO 60296 | <=0.01 | 0.01 |
| Water content, mg/kg | IEC 61814 | <=30 bulk | 9 |
| | | <=40 drum | |
| I.R. Structural analysis | | | |
| Aromatic hydrocarbon, % | IEC 60590 | — | 1.2 |
| Paraffinic hydrocarbon, % | BRANDES | — | 68.4 |
| Naphthenic hydrocarbon, % | BRANDES | — | 30.4 |
| Antioxidant additive | IEC 60666 | 0.08-0.40% | 0.18 |
| Phenol type | | inhibited oil | |
| Furanic derivatives, mg/kg | IEC 61198 | <=0.1 | <0.01 |
| Corrosive sulphur | ISO 5662 | non-corrosive | non-corrosive |
| Total sulphur, ppm | IMPA.S | Not specified | <1 |
| | method | | |
| PAH % | IP 346 | <=3 | 0.23 |
| PCB mg/kg | IEC 61619 | Not detected | <,2 |
| Gassing tendency μl/min | IEC 60628A | Not specified | 41 |
| Electrical Characteristics | | | |
| Dielectric dissipation factor DDF/90° C. | IEC 60247 | <=50 * 10⁻⁴ | 0.0007 |
| Break-down voltage kv/2.5 mm | IEC 610156 | >30 | 85 |
| | | >70 - treated | |
| Oxidation Stability at 120° C. | IEC 61125C | — | — |
| Test duration (hours) | — | — | 500 |
| Induction period (to 0.28 mgKOH/g AV) hours | — | >500 | >500 |
| Total acidity, mg KOH/g | — | <=1.2 | 0.14 |
| Sludge % | — | <=0.8 | 0.03 |
| Tangens delta 90° C. | — | <=0.5 | 0.008 |

### Example 3

An electrical insulating formulation was formed, containing 94.73 wt. % FTBO XXL (WOW9836), 0.27 wt. % DBPC antioxidant and 5 wt. % Synesstic™ 5 additive. The sample was subject to gassing tendency (ASTM D-2300-1976) and oxidation tests such as rotary pressure vessel oxidation stability or RPVOT (ASTM D 2272-02). The results show a gassing tendency of 27.7 μl/min and 423 minutes for RPVOT at 150° C.

Properties of the FTBO base oils used in Examples 1-3 are shown in Table 3.

TABLE 3

| | Sample/GQ ID | | |
|---|---|---|---|
| | WOW9841 | WOW9843 | WOW9836 |
| Kinematic Viscosity @ 40° C., cSt | 8.016 | 7.813 | 7.658 |
| Kinematic Viscosity @ 100° C., cSt | 2.409 | 2.362 | 2.333 |
| Viscosity Index | 125 | 123 | 124 |
| Cold Crank Viscosity @ −40° C., cP | <900 | <900 | |
| Pour Point, ° C. | −42 | −39 | −46.00 |
| n-d-m | | | |
| Molecular Weight, gm/mol (VPO) | 330 | 329 | 314 |
| Density, gm/ml | 0.8006 | 0.8001 | 0.8026 |
| Refractive Index | 1.4478 | 1.4475 | 1.4485 |
| Paraffinic Carbon, % | 96.13 | 96.14 | 93.13 |
| Naphthenic Carbon, % | 3.87 | 3.86 | 6.87 |
| Aromatic Carbon, % | 0.00 | 0.00 | 0.0 |
| Oxidator BN, hrs | 47.69 | 32.85 | |
| Noack, wt. % (calculated) | 56.2 | 56.63 | 60.69 |
| Saybolt Color | 31.7 | 32.9 | 33.6 |
| HPLC-UV (LUBES) | | | |
| 1-Ring | 0.0181 | 0.0197 | |
| 2-Ring | 0.0004 | 0.0007 | |
| 3-Ring | 0 | 0 | |
| 4-Ring | 0 | 0.0001 | |
| 6-Ring | 0 | 0 | |
| Aromatics Total | 0.0185 | 0.0205 | |
| COC Flash Point, ° C. | 190 | 198 | 192 |
| SIMDIST TBP (WT %), ° F. | | | |
| TBP @0.5 | 590 | 592 | 583 |
| TBP @5 | 625 | 626 | 622 |
| TBP @10 | 640 | 641 | 636 |
| TBP @20 | 659 | 660 | 654 |
| TBP @30 | 673 | 673 | 667 |
| TBP @40 | 685 | 685 | 678 |
| TBP @50 | 696 | 695 | 688 |
| TBP @60 | 706 | 704 | 697 |
| TBP @70 | 716 | 714 | 706 |
| TBP @80 | 726 | 724 | 715 |
| TBP @90 | 738 | 735 | 727 |
| TBP @95 | 746 | 744 | 735 |
| TBP @99.5 | 764 | 762 | 753 |
| FIMS by Probe sample introduction | | | |
| Saturates | 83.4 | 75.3 | 72.70 |
| 1-Unsaturation | 14.8 | 20.7 | 19.30 |
| 2-Unsaturation | 1.1 | 2.1 | 3.90 |
| 3-Unsaturation | 0.5 | 1 | 2.00 |
| 4-Unsaturation | 0.1 | 0.6 | 1.70 |
| 5-Unsaturation | 0 | 0.3 | 0.50 |
| 6-Unsaturation | 0 | 0 | 0.00 |
| NMR Parameters | | | |
| Branching Index | 29.67 | 29.59 | 30.21 |
| Branching Proximity | 13.25 | 12.76 | 14.05 |
| Alkyl Branches per Molecule | 2.41 | 2.43 | 2.17 |
| Methyl Branches per Molecule | 2.05 | 2.07 | 1.90 |
| FCI | 3.12 | 3.00 | 3.15 |
| Alkyl Branches per 100 Carbons | 10.20 | 10.34 | 9.67 |
| Methyl Branches per 100 Carbons | 8.70 | 8.79 | 8.48 |
| % Olefins by Proton NMR | 0.00 | 0.00 | 0 |
| Monocycloparaffin (FIMS 1-unsat-NMR | 14.8 | 20.7 | — |
| Olefins) | | | |
| Multicycloparaffin (FIMS 2-Unsat-6Unsat- | 1.7 | 4.0 | — |
| HPLC-UV Aromatics) | | | |
| Mono/Multi ratio | 8.8 | 5.2 | — |

### Biodegradability Examples

The testing for degradation by micro-organisms and assessment of the toxicity of materials to micro-organism is an important indication of the biodegradability a material for use as an electrical insulating oil. The biodegradation of the material can be monitored by a variety of parameters such as CO₂ evolution, oxygen consumption and removal of organic carbon or by compound specific methods. One standard test is OECD 301D (closed bottle test), wherein the limit for “readily” biodegradable is >=60% and the limit for moderately or inherently biodegradable is 20%.

A number of isomerized base oils FTBO from Chevron Corporation were subject to OECD 301D (closed bottle test). Properties of the FTBO oils used in the biodegradability test and the OECD 301D results are shown in Table 4.

TABLE 4

| FT isomerized oils used | XL | L | M | XXL | H |
|---|---|---|---|---|---|
| Results | | | | | |
| OECD 301D % | 80 | 43 | 39 | 93 | 29 |
| Properties | | | | | |
| Oxidator BN time, hrs | 35.9 | 41.02 | 42.07 | 42.82 | — |
| NOACK WT. LOSS, % | 26.8 | 10.22 | 2.49 | 81.9 | — |
| VI | 125 | 138 | 153 | 116, 119 | 156 |
| Kin. Visc. @ 100 C., mm²/sec | 2.988 | 4.12 | 7.129 | 2.028 | 14.84 |
| Kin. Visc. @ 40 C., mm²/sec | 11.16 | 17.74 | 37.92 | 6.323 | 99.38 |
| COC Flash Point, F. | 206 | 232 | 258 | 168, 180 | 210 |
| TGA NOACK/Oil Volatility, wt % | 32.42 | 12.29 | 2.82 | 84.59 | — |
| Density | 0.8059 | 0.8128 | 0.8222 | 0.7956 | — |
| Molecular Weight | 375 | 431 | 540 | 320 | — |
| RI | 1.4507 | 1.4541 | 1.459 | 1.4453 | — |
| Density Temp, ° C. | 20 | 20 | 20 | 20 | — |
| RI Temp, ° C. | 20 | 20 | 20 | 20 | — |
| Pour, ° C. | −36 | −27 | −20 | −57 | −12 |
| Cloud, ° C. | −26 | −20 | −13 | −33.2 | 15 |
| SIMDIST TBP (WT %), ° F. | | | | | |
| TBP @0.5 | 679 | 732 | 805 | 534 | — |
| TBP @5 | 701 | 758 | 836 | 588 | — |
| TBP @10 | 709 | 770 | 850 | 604 | — |
| TBP @20 | 720 | 784 | 869 | 625 | — |
| TBP @30 | 728 | 795 | 884 | 640 | — |
| TBP @40 | 735 | 805 | 897 | 652 | — |
| TBP @50 | 741 | 813 | 913 | 663 | — |
| TBP @60 | 748 | 822 | 930 | 672 | — |
| TBP @70 | 756 | 832 | 947 | 682 | — |
| TBP @80 | 764 | 843 | 973 | 692 | — |
| TBP @90 | 774 | 857 | 1004 | 702 | — |
| TBP @95 | 782 | 867 | 1033 | 709 | — |
| TBP @99.5 | 802 | 887 | 1093 | 724 | — |

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. It is noted that, as used in this specification and the appended claims, the singular forms “a,” “an,” and “the,” include plural referents unless expressly and unequivocally limited to one referent. As used herein, the term “include” and its grammatical variants are intended to be non-limiting, such that recitation of items in a list is not to the exclusion of other like items that can be substituted or added to the listed items.

This written description uses examples to disclose the invention, including the best mode, and also to enable any person skilled in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

All citations referred herein are expressly incorporated herein by reference.

1. An electrical insulating oil composition in compliance with at least one of ASTM D 3487-2000 and IEC 60296-2003, the composition comprising
(a) a lubricating base oil and
(b) 0.001 to 10 wt % at least an additive selected from an additive package, an oxidation inhibitor, anti-gassing agent, pour point depressant, metal deactivator, metal passivator, anti-foaming agent, and mixtures thereof;
wherein the lubricating base oil has a biodegradability of at least 30% as measured according to OECD 301D, consecutive numbers of carbon atoms, and less than 10 wt % naphthenic carbon by n-d-M.

2. The electrical insulating oil composition of claim 1, wherein the lubricating base oil has a kinematic viscosity at 100° C. in the range of 2.0-3.8 mm²/s and a Noack volatility less than an amount defined by the equation: 900×(kinematic viscosity at 100° C.)^{-2.8}−15).

3. The electrical insulating oil composition of claim 2, wherein the lubricating base oil has a weight percent of all molecules with at least one aromatic function less than 0.30; b) a weight percent of all molecules with at least one cycloparaffin function greater than 10; c) a ratio of weight percent of molecules containing monocycloparaffins to weight percent of molecules containing multicycloparaffins greater than 20; and d) a viscosity index greater than 28×Ln(kinematic viscosity at 100° C.)+80.

4. The electrical insulating oil composition of claim 1, wherein the lubricating base oil has an average molecular weight between 600 and 1100, and an average degree of branching in the molecules between 6.5 and 10 alkyl branches per 100 carbon atoms.

5. The electrical insulating oil composition of claim 1, wherein the lubricating base oil has an auto-ignition temperature in ° C. (AIT) greater than an AIT in ° C. defined by: 1.6×(kinematic viscosity at 40° C., in mm²/s)+300.

6. The electrical insulating oil composition of claim 1, wherein the lubricating base oil has a traction coefficient less than an amount calculated by: 0.009×Ln(kinematic viscosity in mm²/s)−0.001, wherein the kinematic viscosity is the viscosity of the oil during the measurement of the traction coefficient.

7. The electrical insulating oil composition of claim 1, wherein the lubricating base oil consists essentially of at least an isomerized base oil having a biodegradability of at least 80% as measured according to OECD 301D.

8. The electrical insulating oil composition of claim 7, wherein the lubricating base oil consists essentially of at least an isomerized base oil having a biodegradability of at least 90% as measured according to OECD 301D.

9. The electrical insulating oil composition of claim 1, wherein the electrical insulating oil displays a gassing tendency of <30 μL per minute as measured according to ASTM D-2300-1976.

10. The electrical insulating oil composition of claim 9, wherein the electrical insulating oil displays a gassing tendency of <20 μL per minute as measured according to ASTM D-2300-1976.

11. The electrical insulating oil composition of claim 1, wherein the electrical insulating oil displays a rotary pressure vessel oxidation stability (RPVOT) value of at least 400 minutes as measured according to ASTM D 2272-02.

12. The electrical insulating oil composition of claim 11, wherein the electrical insulating oil displays a rotary pressure vessel oxidation stability (RPVOT) value of at least 500 minutes as measured according to ASTM D 2272-02.

13. The electrical insulating oil composition of claim 1, wherein the additive is a hydrogen donor.

14. The electrical insulating oil composition of claim 13, wherein the additive is an alkylated naphthalene in an amount of 1 to 6 wt. %.

15. The electrical insulating oil composition of claim 1, wherein the additive is a pour point depressant selected from the group of: pour point reducing blend components; polymethacrylates; polyacrylates; polyacrylamides; condensation products of haloparaffin waxes and aromatic compounds; vinyl carboxylate polymers; terpolymers of dialkylfumarates, vinyl esters of fatty acids, and alkyl vinyl ethers; and mixtures thereof.

16. The electrical insulating oil composition of claim 1, wherein the additive is an antioxidant selected from the group consisting of phenolics, aromatic amines, compounds containing sulfur and phosphorus, organosulfur compounds, organophosphorus compounds, and mixtures thereof.

17. The electrical insulating oil composition of claim 16, wherein the additive is a phenolic antioxidant.

18. The electrical insulating oil composition of claim 1, wherein the additive is a metal deactivator selected from the group consisting of triazoles, benzotriazoles, tolyltriazoles, tolyltriazole derivatives, and mixtures thereof.

19. The electrical insulating oil composition of claim 18, wherein the metal deactivator is a triazole and the metal deactivator is present in an amount between 0.001 to 1 wt. %.

20. The electrical insulating oil composition of claim 18, wherein the composition comprises 0.001 to 1.0 wt. % of N,N-bis(2-Ethylhexyl)-1H-1,2,4-triazole-1 methanamine as a metal deactivator and 0.001 to 1 wt % of 2,6-Di-tert.butyl-4-methylphenol as an antioxidant.

21. The electrical insulating oil composition of claim 1, wherein the lubricating base oil has a sulfur content of less than 10 ppm.

22. The electrical insulating oil composition of claim 21, wherein the lubricating base oil has a sulfur content of less than 5 ppm.

23. The electrical insulating oil composition of claim 22, wherein the lubricating base oil has a sulfur content of less than 1 ppm.

24. An electrical equipment comprising the electrical insulating oil composition of claim 1 for cooling and/or insulating.

25. A medical equipment comprising the electrical insulating oil composition of claim 1 for cooling and/or insulating.
